(19) United States
(12) Patent Application Publication
(10) Pub. No.: US 2015/0307705 A1
(43) Pub. Date: Oct. 29, 2015

(54) FLAME-RETARDANT POLYCARBONATE MOLDING MATERIALS II

(71) Applicant: BAYER MATERIALSCIENCE AG, Leverkusen (DE)

(72) Inventors: Mathieu JUNG, Shanghai (CN); Thomas ECKEL, Dormagen (DE); Vera TASCHNER, Langenfeld (DE)

(21) Appl. No.: 14/648,934

(22) PCT Filed: Dec. 5, 2013
(86) PCT No.: PCT/EP2013/075714

§ 371 Date: Jun. 2, 2015

(30) Foreign Application Priority Data
Dec. 7, 2012 (EP) 12196015.7

(51) Int. Cl. C08L 69/00; C07F 9/659

(52) U.S. Cl. CPC C08L 69/00; C07F 9/659; C08L 2201/02

(57) ABSTRACT

The present invention relates to flameproofed polycarbonate (PC) compositions and moulding compounds which have modified impact strength, high-temperature stability and high hydrolysis stability.

The present patent application further relates to the use of the compositions for the production of moulded articles, and to the moulded articles produced from the compositions.

The present invention relates to flameproofed polycarbonate (PC) compositions comprising cyclic phosphazenes which have modified impact strength, high-temperature stability, high hydrolysis stability and good notched impact strength, to processes for their preparation and to the use of cyclic phosphazenes as flameproofing agents in polycarbonate compositions.

EP 1 095 099 A1 describes polycarbonate/ABS moulding compounds comprising phosphazenes and phosphorus compounds, which have excellent flame resistance and very good mechanical properties such as weld strength or notched impact strength.

EP 1 196 498 A1 describes moulding compounds comprising phosphazenes and based on polycarbonate and graft polymers selected from the group comprising silicone rubbers, EP(D)M rubbers and acrylate rubbers as the graft base, which have excellent flame resistance and very good mechanical properties such as stress cracking resistance or notched impact strength.

EP 1 095 100 A1 describes polycarbonate/ABS moulding compounds comprising phosphazenes and inorganic nanoparticles, which have excellent flame resistance and very good mechanical properties.

EP 1 095 097 A1 describes polycarbonate/ABS moulding compounds comprising phosphazenes, which have excellent flame resistance and very good processing properties, the graft polymer being prepared by bulk, solution or mass-suspension polymerization processes.

The documents cited above disclose linear and cyclic phosphazenes. In the case of cyclic phosphazenes, however, the proportions of trimers, tetramers and higher oligomers are not specified.

US2003/092802 A1 discloses phenoxyphosphazenes and their preparation and use in polycarbonate/ABS moulding compounds. The phenoxyphosphazenes are preferably crosslinked and the moulding compounds are distinguished by good flame resistance, good impact strength, high flexural modulus and high melt volume-flow rate. The ABS used is not described in greater detail. Furthermore, said document does not describe the proportions of trimers, tetramers and higher oligomers of the present patent application.

JP 2004 155802 discloses cyclic phosphazenes and their use in thermoplastic moulding compounds such as polycarbonate and ABS. Polycarbonate/ABS moulding compounds comprising cyclic phosphazenes with precisely defined proportions of trimers, tetramers and higher oligomers are not disclosed.

JP 1995 0038462 describes polycarbonate compositions comprising graft polymers, phosphazenes as flameproofing agents and optionally vinyl copolymers, although specific structures, compositions and amounts of the flameproofing agent are not mentioned.

JP 1999 0176718 describes thermoplastic compositions consisting of aromatic polycarbonate, copolymer of aromatic vinyl monomers and vinyl cyanides, graft polymer of alkyl (meth)acrylates and rubber, and phosphazene as flameproofing agent, which have a good flowability.

The object of the present invention is thus to provide a flameproofed moulding compound which is distinguished by a combination of properties consisting of good notched impact strength, high dimensional stability under heat and high hydrolysis stability, the UL 94 V-0 classification remaining good at 1.5 mm.

Preferably, the moulding compounds are flame-resistant and satisfy the UL 94 requirements with V-0, even at low wall thicknesses (i.e. wall thickness of 1.5 mm).

It was found, surprisingly, that compositions comprising
A) 48-95 parts by weight, preferably 65-90 parts by weight, more preferably 70-85 parts by weight and particularly preferably 73-88 parts by weight of aromatic polycarbonate and/or aromatic polyestercarbonate,
B) 1.0-20.0 parts by weight, preferably 3.0-18.0 parts by weight and particularly preferably 4.0-16.0 parts by weight of rubber-modified graft polymer,
C) 1.0-20.0 parts by weight, preferably 1.5-18.0 parts by weight, more preferably 2.0-15.0 parts by weight and particularly preferably 4.0-10.0 parts by weight of at least one cyclic phosphazene of structure (X):

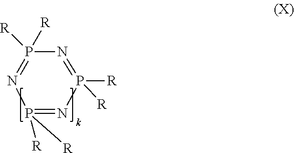

where
k is 1 or an integer from 1 to 10, preferably a number from 1 to 8 and particularly preferably 1 to 5,
with a trimer content (k=1) of 60 to 98 mol %, more preferably of 65 to 95 mol %, particularly preferably of 65 to 90 mol % and very particularly preferably of 65-85 mol %, especially of 70 mol %, based on component C,
and
R are in each case identical or different and are an amine radical, C₁- to C₈-alkyl in each case optionally halogenated, preferably with fluorine, preferably methyl, ethyl, propyl or butyl, C₁- to C₈-alkoxy, preferably methoxy, ethoxy, propoxy or butoxy, C₅- to C₆-cycloalkyl in each case optionally substituted by alkyl, preferably C₁-C₄-alkyl, and/or halogen, preferably chlorine and/or bromine, C₆- to C₂₀-aryloxy in each case optionally substituted by alkyl, preferably C₁-C₄-alkyl, and/or halogen, preferably chlorine or bromine, and/or hydroxyl, preferably phenoxy or naphthyloxy, C₇- to C₁₂-aralkyl in each case optionally substituted by alkyl, preferably C₁-C₄-alkyl, and/or halogen, preferably chlorine and/or bromine, preferably phenyl-C₁-C₄-alkyl, or a halogen radical, preferably chlorine, or an OH radical,
D) 1.0-7.0 parts by weight, preferably 1.5-6.5 parts by weight, more preferably 2.0-6.0 parts by weight and particularly preferably 2.2-5.5 parts by weight of at least one phosphorus-containing organic flameproofing agent other than C,
E) 0-15.0 parts by weight, preferably 2.0-12.5 parts by weight, more preferably 3.0-9.0 parts by weight and particularly preferably 3.0-6.0 parts by weight of rubber-free vinyl (co)polymer or polyalkylene terephthalates,
F) 0-15.0 parts by weight, preferably 0.05-15.00 parts by weight, more preferably 0.2-10.0 parts by weight and particularly preferably 0.4-5.0 parts by weight of additives and
G) 0.05 to 5.0 parts by weight, preferably 0.1 to 2.0 parts by weight and particularly preferably 0.1 to 1.0 part by weight of antidripping agent,

all the parts by weight in the present patent application preferably being scaled so that the sum of the parts by weight of all the components A+B+C+D+E+F+G in the composition is 100, and

at least 50% of the amount of phosphorus in the whole composition originating from component C.

In one preferred embodiment the composition consists only of components A to G.

The desired combination of properties is achieved when at least 50% of the amount of phosphorus required to achieve the UL 94 V-0 classification at 1.5 mm originates from component C.

In one preferred embodiment the composition is free of inorganic flameproofing agents and flameproofing synergistic agents, especially aluminium hydroxide, aluminium oxide-hydroxide and arsenic and antimony oxides.

In another preferred embodiment, in which component B is a bulk polymer B2, the proportion of component B is particularly preferably 10-18 wt %, based on the whole composition.

The preferred embodiments can be carried out individually or in combination with one another.

The invention also provides processes for the preparation of the moulding compounds, the use of the moulding compounds for the production of moulded articles and the use of cyclic phosphazenes of defined oligomer distribution for the preparation of the compositions according to the invention.

The moulding compounds according to the invention can be used for the production of all kinds of moulded articles. These can be produced by injection moulding, extrusion and blow moulding processes. Another form of processing is the production of moulded articles by deep drawing from previously produced sheets or films.

Examples of such moulded articles are films; profiles; all kinds of housing parts, e.g. for domestic appliances such as juice presses, coffee machines and mixers, or for office machines such as monitors, flat screens, notebooks, printers and copiers; sheets; tubes; electrical conduits; windows, doors and other profiles for the building sector (interior and exterior applications); electrical and electronic parts such as switches, plugs and sockets; and body parts or interior trim for commercial vehicles, especially for the motor vehicle sector.

In particular, the moulding compounds according to the invention can also be used e.g. for the production of the following moulded articles or moulded parts: interior trim for rail vehicles, ships, aeroplanes, buses and other motor vehicles, housings for electrical equipment containing small transformers, housings for information processing and transmission equipment, housings and sheathing for medical equipment, housings for safety devices, moulded parts for sanitary and bath fittings, covering grids for ventilation apertures and housings for garden tools.

Component A

Aromatic polycarbonates and/or aromatic polyestercarbonates that are suitable according to the invention as component A are known in the literature or can be prepared by processes known in the literature (for the preparation of aromatic polycarbonates see e.g. Schnell, “Chemistry and Physics of Polycarbonates”, Interscience Publishers, 1964, and DE-AS 1 495 626, DE-A 2 232 877, DE-A 2 703 376, DE-A 2 714 544, DE-A 3 000 610 and DE-A 3 832 396; for the preparation of aromatic polyestercarbonates see e.g. DE-A 3 007 934).

Aromatic polycarbonates are prepared e.g. by reacting diphenols with carbonic acid halides, preferably phosgene, and/or with aromatic dicarboxylic acid dihalides, preferably benzenedicarboxylic acid dihalides, by the phase interface process, optionally using chain terminators, e.g. monophenols, and optionally using trifunctional or more than trifunctional branching agents, e.g. triphenols or tetra-phenols. They can also be prepared by reacting diphenols with e.g. diphenyl carbonate by a melt polymerization process.

Diphenols for the preparation of the aromatic polycarbonates and/or aromatic polyestercarbonates are preferably those of formula (I):

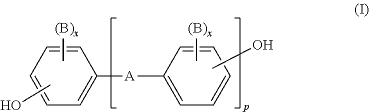

where
A is a single bond, C₁- to C₅-alkylene, C₂- to C₅-alkylidene, C₅- to C₆-cyclo-alkylidene, —O—, —SO—, —CO—, —S—, —SO₂—, C₆- to C₁₂-arylene to which further aromatic rings optionally containing heteroatoms can be fused,
   or a radical of formula (II) or (III):

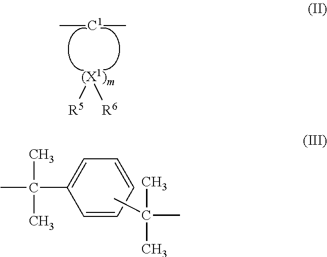

B are in each case C₁- to C₁₂-alkyl, preferably methyl, or halogen, preferably chlorine and/or bromine,
x independently of one another are in each case 0, 1 or 2,
p is 1 or 0 and
R⁵ and R⁶ can be individually chosen for each X¹ and independently of one another are hydrogen or C₁- to C₆-alkyl, preferably hydrogen, methyl or ethyl,
X¹ is carbon and
m is an integer from 4 to 7, preferably 4 or 5, with the proviso that R⁵ and R⁶
   are simultaneously alkyl on at least one atom X¹.

Preferred diphenols are hydroquinone, resorcinol, dihydroxydiphenols, bis(hydroxy-phenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxy-phenyl) sulfones and α,α-bis(hydroxyphenyl)diisopropylbenzenes, and their ring-brominated and/or ring-chlorinated derivatives.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone and their di- and tetrabrominated or chlorinated derivatives, e.g. 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-Bis-(4-hydroxyphenyl)propane (bisphenol A) is particularly preferred.

The diphenols can be used individually or as any desired mixtures. The diphenols are known in the literature or obtainable by processes known in the literature.

Examples of suitable chain terminators for the preparation of the thermoplastic aromatic polycarbonates are phenol, p-chlorophenol, p-tert-butylphenol or 2,4,6-tribromophenol, as well as long-chain alkylphenols such as 4-[2-(2,4,4-trimethyl-pentyl)]phenol and 4-(1,3-tetramethylbutyl)phenol according to DE-A 2 842 005, or monoalkylphenols or dialkylphenols having a total of 8 to 20 carbon atoms in the alkyl substituents, such as 3,5-ditert-butylphenol, p-isooctylphenol, p-tert-octyl-phenol, p-dodecylphenol, 2-(3,5-dimethylheptyl)phenol and 4-(3,5-dimethylheptyl)-phenol. The amount of chain terminators to be used is generally between 0.5 mol % and 10 mol %, based on the molar sum of the particular diphenols used.

The thermoplastic aromatic polycarbonates have weight-average molecular weights (M_{w}, measured by GPC (gel permeation chromatography) with polycarbonate as standard) of 15,000 to 80,000 g/mol, preferably of 19,000 to 32,000 g/mol and particularly preferably of 22,000 to 30,000 g/mol.

The thermoplastic aromatic polycarbonates can be branched in known manner, preferably by the incorporation of 0.05 to 2.0 mol %, based on the sum of the diphenols used, of trifunctional or more than trifunctional compounds, e.g. those with three or more phenolic groups. The polycarbonates used are preferably linear and more preferably based on bisphenol A.

Both homopolycarbonates and copolycarbonates are suitable. Copolycarbonates according to the invention as component A can also be prepared using 1 to 25 wt %, preferably 2.5 to 25 wt % (based on the total amount of diphenols to be used), of polydiorganosiloxanes with hydroxyaryloxy end groups. These are known (U.S. Pat. No. 3,419,634) and can be prepared by processes known in the literature. Copolycarbonates comprising polydiorganosiloxanes are also suitable; the preparation of copolycarbonates comprising polydiorganosiloxanes is described e.g. in DE-A 3 334 782.

Aromatic dicarboxylic acid dihalides for the preparation of aromatic polyestercarbonates are preferably the diacid dichlorides of isophthalic acid, terephthalic acid, diphenyl ether 4,4′-dicarboxylic acid and naphthalene-2,6-dicarboxylic acid.

Mixtures of the diacid dichlorides of isophthalic acid and terephthalic acid in a ratio of between 1:20 and 20:1 are particularly preferred.

A carbonic acid halide, preferably phosgene, is additionally used concomitantly as a difunctional acid derivative in the preparation of polyestercarbonates.

Suitable chain terminators for the preparation of the aromatic polyestercarbonates, apart from the monophenols already mentioned, are their chlorocarbonic acid esters and the acid chlorides of aromatic monocarboxylic acids which can optionally be substituted by C₁- to C₂₂-alkyl groups or halogen atoms, as well as aliphatic C₂- to C₂₂-monocarboxylic acid chlorides.

The amount of chain terminators is 0.1 to 10 mol % in each case, based on moles of diphenol for phenolic chain terminators and on moles of dicarboxylic acid dichloride for monocarboxylic acid chloride chain terminators.

One or more aromatic hydroxycarboxylic acids can additionally be used in the preparation of aromatic polyestercarbonates.

The aromatic polyestercarbonates can be both linear and branched in known manner (cf. DE-A 2 940 024 and DE-A 3 007 934 in this connection), linear polyestercarbonates being preferred.

Examples of branching agents which can be used are trifunctional or more than trifunctional carboxylic acid chlorides such as trimesic acid trichloride, cyanuric acid trichloride, benzophenone-3,3′,4,4′-tetracarboxylic acid tetrachloride, naphthalene-1,4,5,8-tetracarboxylic acid tetrachloride or pyromellitic acid tetrachloride, in amounts of 0.01 to 1.0 mol % (based on the dicarboxylic acid dichlorides used), or trifunctional or more than trifunctional phenols such as phloroglucinol, 4,6-dimethyl-2,4,6-tri(4-hydroxyphenyl)-2-heptene, 4,6-dimethyl-2,4,6-tri(4-hydroxy-phenyl)heptane, 1,3,5-tri(4-hydroxyphenyl)benzene, 1,1,1-tri(4-hydroxyphenyl)-ethane, tri(4-hydroxyphenyl)phenylmethane, 2,2-bis[4,4-bis(4-hydroxyphenyl)-cyclohexyl]propane, 2,4-bis(4-hydroxyphenylisopropyl)phenol, tetra(4-hydroxy-phenyl)methane, 2,6-bis(2-hydroxy-5-methylbenzyl)-4-methylphenol, 2-(4-hydroxy-phenyl)-2-(2,4-dihydroxyphenyl)propane, tetra(4-[4-hydroxyphenylisopropyl]-phenoxy)methane or 1,4-bis[4,4′-(dihydroxytriphenyl)methyl]benzene, in amounts of 0.01 to 1.0 mol %, based on the diphenols used. Phenolic branching agents can be used with the diphenols; acid chloride branching agents can be introduced together with the acid dichlorides.

The proportion of carbonate structural units in the thermoplastic aromatic polyestercarbonates can vary freely. The proportion of carbonate groups is preferably up to 100 mol %, especially up to 80 mol % and particularly preferably up to 50 mol %, based on the sum of the ester groups and carbonate groups. Both the ester part and the carbonate part of the aromatic polyestercarbonates can be present in the polycondensation product in the form of blocks or as a random distribution.

The thermoplastic aromatic polycarbonates and polyestercarbonates can be used on their own or in any desired mixture.

Component B

Graft polymers suitable as component B are both emulsion polymers B1 and bulk polymers B2, as well as mixtures of B1 and B2.

In one preferred embodiment component B consists only of polymers B2.

In one preferred embodiment component B1 consists of graft polymers, prepared by the emulsion polymerization process, of

B1.1) 5 to 95 wt %, preferably 10 to 70 wt % and particularly preferably 20 to 60 wt %, based on component B1, of a mixture of

B1.1.1) 65 to 85 wt %, preferably 70 to 80 wt %, based on B1.1, of at least one monomer selected from the group comprising vinylaromatics (e.g. styrene, α-methylstyrene), ring-substituted vinylaromatics (e.g. p-methylstyrene, p-chlorostyrene) and methacrylic acid C₁-C₈-alkyl esters (e.g. methyl methacrylate, ethyl methacrylate), and

B1.1.2) 15 to 35 wt %, preferably 20 to 30 wt %, based on B1.1, of at least one monomer selected from the group comprising vinyl cyanides (e.g. unsaturated nitriles like acrylonitrile and methacrylonitrile), (meth)acrylic acid C₁-C₈-alkyl esters (e.g. methyl methacrylate, n-butyl acrylate, tert-butyl acrylate) and derivatives (e.g. anhydrides and imides) of unsaturated carboxylic acids (e.g. maleic anhydride and N-phenylmaleimide),

on

B1.2) 95 to 5 wt %, preferably 90 to 30 wt % and particularly preferably 80 to 40 wt %, based on component B1, of at least one elastomeric graft base.

The glass transition temperature of the graft base is preferably <0° C., more preferably <−20° C. and particularly preferably <−60° C.

Unless indicated otherwise in the present invention, glass transition temperatures are determined by differential scanning calorimetry (DSC) according to standard DIN EN 61006 at a heating rate of 10 K/min with Tg defined as the mid-point temperature (tangent method) and nitrogen as the inert gas.

The graft particles in component B1 preferably have a mean size (d₅₀ value) of 0.05 to 5 μm, preferably of 0.1 to 1.0 μm and particularly preferably of 0.2 to 0.5 μm.

The mean particle size d₅₀ is the diameter above which 50 wt % of the particles fall and below which 50 wt % of the particles fall. Unless explicitly stated otherwise in the present patent application, it is determined by ultracentrifuge measurement (W. Scholtan, H. Lange, Kolloid-Z. and Z. für Polymere 250 (1972), 782-796).

Preferred monomers B1.1.1 are selected from at least one of the monomers styrene, α-methylstyrene and methyl methacrylate; preferred monomers B1.1.2 are selected from at least one of the monomers acrylonitrile, maleic anhydride and methyl methacrylate.

Particularly preferred monomers B1.1.1 and B1.1.2 are styrene and acrylonitrile respectively.

Examples of suitable graft bases B1.2 for the graft polymers B1 are diene rubbers, diene/vinyl block copolymer rubbers, EP(D)M rubbers, i.e. those based on ethylene/propylene and optionally diene, and acrylate, polyurethane, silicone, chloroprene and ethylene/vinyl acetate rubbers, as well as mixtures of such rubbers, or silicone/acrylate composite rubbers in which the silicone and acrylate components are chemically coupled together (e.g. by grafting).

Preferred graft bases B1.2 are diene rubbers (e.g. those based on butadiene or isoprene), diene/vinyl block copolymer rubbers (e.g. those based on butadiene and styrene blocks), copolymers of diene rubbers with other copolymerizable monomers (e.g. according to B1.1.1 and B1.1.2) and mixtures of the aforesaid types of rubber. Pure polybutadiene rubber and styrene/butadiene block copolymer rubber are particularly preferred.

The gel content of the graft polymers is at least 40 wt %, preferably at least 60 wt % and particularly preferably at least 75 wt % (measured in acetone).

Unless stated otherwise in the present invention, the gel content of the graft polymers is determined at 25° C. as the content that is insoluble in acetone as solvent (M. Hoffmann, H. Krömer, R. Kuhn, Polymeranalytik I and II, Georg Thieme-Verlag, Stuttgart 1977).

The graft polymers B1 are prepared by free-radical polymerization.

As a result of the preparative process, the graft polymer B1 generally comprises free copolymer of B1.1.1 and B1.1.2, i.e. copolymer not chemically bonded to the rubber base, which is distinguished in that it can be dissolved in suitable solvents (e.g. acetone).

Component B1 preferably comprises a free copolymer of B1.1.1 and B1.1.2 having a weight-average molecular weight (M_{w}), determined by gel permeation chromatography with polystyrene as standard, preferably of 30,000 to 150,000 g/mol, particularly preferably of 40,000 to 120,000 g/mol.

As component B2 the compositions according to the invention can optionally comprise graft polymers prepared by the bulk, solution or suspension polymerization process. In one preferred embodiment these are graft polymers of

B2.1) 5 to 95 wt %, preferably 80 to 93 wt %, particularly preferably 85 to 92 wt % and very particularly preferably 87 to 93 wt %, based on component B2, of a mixture of

B2.1.1) 65 to 85 wt %, preferably 70 to 80 wt %, based on the mixture B2.1, of at least one monomer selected from the group comprising vinylaromatics (e.g. styrene, α-methylstyrene), ring-substituted vinylaromatics (e.g. p-methylstyrene, p-chlorostyrene) and methacrylic acid C₁-C₈-alkyl esters (e.g. methyl methacrylate, ethyl methacrylate), and

B2.1.2) 15 to 35 wt %, preferably 20 to 30 wt %, based on the mixture B2.1, of at least one monomer selected from the group comprising vinyl cyanides (e.g. unsaturated nitriles like acrylonitrile and methacrylonitrile), (meth)acrylic acid C₁-C₈-alkyl esters (e.g. methyl methacrylate, n-butyl acrylate, tert-butyl acrylate) and derivatives (e.g. anhydrides and imides) of unsaturated carboxylic acids (e.g. maleic anhydride and N-phenylmaleimide),

on

B2.2) 95 to 5 wt %, preferably 20 to 7 wt %, particularly preferably 15 to 8 wt % and very particularly preferably 13 to 7 wt %, based on component B2, of

at least one graft base.

The glass transition temperature of the graft base is preferably <0° C., more preferably <−20° C. and particularly preferably <−60° C.

The graft particles in component B2 preferably have a mean size (d₅₀ value) of 0.1 to 10 μm, preferably of 0.2 to 2 μm, particularly preferably of 0.3 to 1.0 μm and very particularly preferably of 0.3 to 0.6 μm.

Preferred monomers B2.1.1 are selected from at least one of the monomers styrene, α-methylstyrene and methyl methacrylate; preferred monomers B2.1.2 are selected from at least one of the monomers acrylonitrile, maleic anhydride and methyl methacrylate.

Particularly preferred monomers B2.1.1 and B2.1.2 are styrene and acrylonitrile respectively.

Examples of suitable graft bases B2.2 for the graft polymers B2 are diene rubbers, diene/vinyl block copolymer rubbers, EP(D)M rubbers, i.e. those based on ethylene/propylene, and mixtures of such rubbers.

Preferred graft bases B2.2 are diene rubbers (e.g. those based on butadiene or isoprene), diene/vinyl block copolymer rubbers (e.g. those based on butadiene and styrene blocks), copolymers of diene rubbers with other copolymerizable monomers (e.g. according to B2.1.1 and B2.1.2) and mixtures of the aforesaid types of rubber. Styrene/butadiene block copolymer rubbers and mixtures of styrene/butadiene block copolymer rubbers with pure polybutadiene rubber are particularly preferred as the graft base B2.2.

The gel content of the graft polymers B2 is preferably 10 to 35 wt %, particularly preferably 15 to 30 wt % and very particularly preferably 17 to 23 wt % (measured in acetone).

Examples of particularly preferred polymers B2 are ABS polymers prepared by free-radical polymerization, which, in one preferred embodiment, comprise up to 10 wt %, preferably up to 5 wt % and particularly preferably 2 to 5 wt %, based in each case on the graft polymer B2, of n-butyl acrylate.

As a result of the preparative process, the graft polymer B2 generally comprises free copolymer of B2.1.1 and B2.1.2, i.e. copolymer not chemically bonded to the rubber base, which is distinguished in that it can be dissolved in suitable solvents (e.g. acetone).

Component B2 preferably comprises a free copolymer of B2.1.1 and B2.1.2 having a weight-average molecular weight (M_{w}), determined by gel permeation chromatography with polystyrene as standard, preferably of 50,000 to 200,000 g/mol, particularly preferably of 70,000 to 150,000 g/mol and particularly preferably of 80,000 to 120,000 g/mol.

Component C

Phosphazenes of component C which are used according to the present invention are cyclic phosphazenes of formula (X):

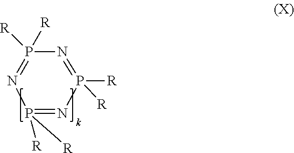

where
R are in each case identical or different and are
   an amine radical,
   C₁- to C₈-alkyl in each case optionally halogenated, preferably with fluorine and more preferably monohalogenated, preferably methyl, ethyl, propyl or butyl,
   C₁- to C₈-alkoxy, preferably methoxy, ethoxy, propoxy or butoxy,
   C₅- to C₆-cycloalkyl in each case optionally substituted by alkyl, preferably C₁-C₄-alkyl, and/or halogen, preferably chlorine and/or bromine,
   C₆- to C₂₀-aryloxy in each case optionally substituted by alkyl, preferably C₁-C₄-alkyl, and/or halogen, preferably chlorine or bromine, and/or hydroxyl, preferably phenoxy or naphthyloxy,
   C₇- to C₁₂-aralkyl in each case optionally substituted by alkyl, preferably C₁-C₄-alkyl, and/or halogen, preferably chlorine and/or bromine, preferably phenyl-C₁-C₄-alkyl, or
   a halogen radical, preferably chlorine or fluorine, or
   an OH radical, and
k is as defined above.

The following are preferred:

propoxyphosphazene, phenoxyphosphazene, methylphenoxyphosphazene, amino-phosphazene and fluoroalkylphosphazenes, as well as phosphazenes of the following structures:

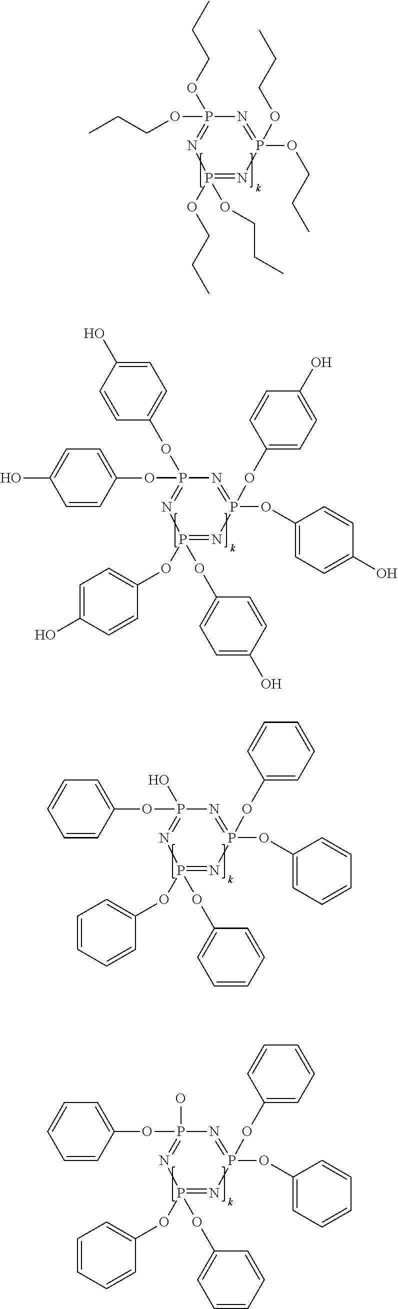

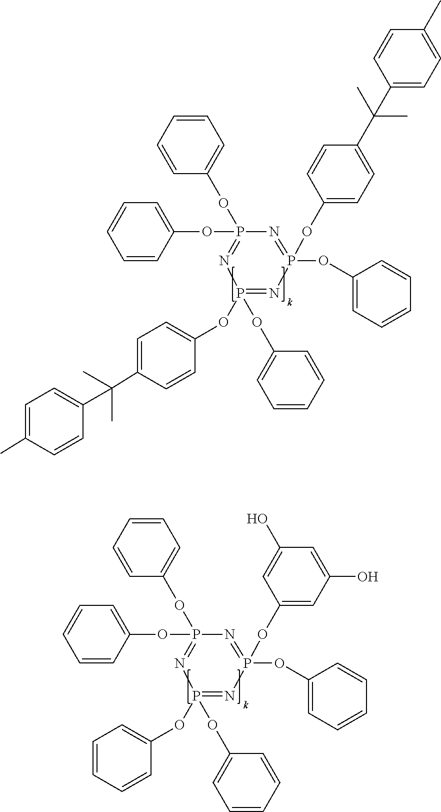

In the compounds shown above, k=1, 2 or 3.

The preferred compound is phenoxyphosphazene (all R=phenoxy) with an oligomer content where k=1 (C1) of 60 to 98 mol %.

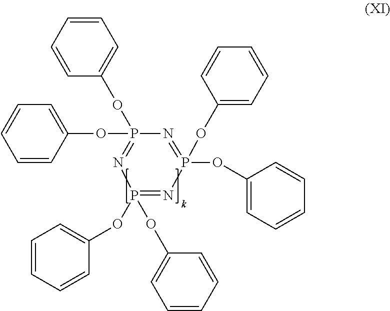

In the case where the phosphazene of formula (X) is halogen-substituted on the phosphorus, e.g. from incompletely reacted starting material, the proportion of this phosphazene halogen-substituted on the phosphorus is preferably less than 1000 ppm, more preferably less than 500 ppm.

The phosphazenes can be used on their own or as a mixture, i.e. the radicals R can be identical or 2 or more radicals in formula (X) can be different. Preferably, the radicals R of a phosphazene are identical.

In another preferred embodiment, only phosphazenes with identical R are used.

In one preferred embodiment the tetramer content (k=2) (C2), based on component C, is from 2 to 50 mol %, more preferably from 5 to 40 mol %, even more preferably from 10 to 30 mol % and particularly preferably from 10 to 20 mol %.

In one preferred embodiment the higher oligomeric phosphazene content (k=3, 4, 5, 6 and 7) (C3), based on component C, is from 0 to 30 mol %, more preferably from 2.5 to 25 mol %, even more preferably from 5 to 20 mol % and particularly preferably from 6 to 15 mol %.

In one preferred embodiment the oligomer content where k≧8 (C4), based on component C, is from 0 to 2.0 mol %, preferably from 0.10 to 1.00 mol %.

In another preferred embodiment the phosphazenes of component C satisfy all three of the aforementioned conditions in respect of contents (C2-C4).

Preferably, component C is a phenoxyphosphazene with a trimer content (k=1) of 65 to 85 mol %, a tetramer content (k=2) of 10 to 20 mol %, a higher oligomeric phosphazene content (k=3, 4, 5, 6 and 7) of 5 to 20 mol % and a phosphazene oligomer content where k≧8 of 0 to 2 mol %, based on component C.

Particularly preferably, component C is a phenoxyphosphazene with a trimer content (k=1) of 70 to 85 mol %, a tetramer content (k=2) of 10 to 20 mol %, a higher oligomeric phosphazene content (k=3, 4, 5, 6 and 7) of 6 to 15 mol % and a phosphazene oligomer content where k≧8 of 0.1 to 1 mol %, based on component C.

In another particularly preferred embodiment, component C is a phenoxyphosphazene with a trimer content (k=1) of 65 to 85 mol %, a tetramer content (k=2) of 10 to 20 mol %, a higher oligomeric phosphazene content (k=3, 4, 5, 6 and 7) of 5 to 15 mol % and a phosphazene oligomer content where k≧8 of 0 to 1 mol %, based on component C.

The weighted arithmetic mean of k is defined by n according to the following formula:

$$n = \frac{{\sum }_{i = 1}^{ma x} {k}_{i} \cdot {x}_{i}}{{\sum }_{i = 1}^{ma x} {x}_{i}}$$

where xᵢ is the content of oligomer so the sum of all xᵢ is equal to 1.

In one alternative embodiment n is in the range from 1.10 to 1.75, preferably from 1.15 to 1.50, more preferably from 1.20 to 1.45 and particularly preferably from 1.20 to 1.40 (inclusive of limits)

The phosphazenes and their preparation are described e.g. in EP-A 728 811, DE-A 1 961 668 and WO 97/40092.

The oligomer compositions of the phosphazenes in the respective blend samples can also be detected and quantified, after compounding, by ³¹P-NMR (chemical shift; δ trimer: 6.5 to 10.0 ppm; δ tetramer: −10 to −13.5 ppm; δ higher oligomers: −16.5 to −25.0 ppm).

Component D

Phosphorus-containing flameproofing agents D in terms of the invention are preferably selected from the groups comprising mono- and oligomeric phosphoric and phosphonic acid esters and phosphonatamines, it also being possible to use as flameproofing agents mixtures of several components selected from one of these groups or from different groups. Other halogen-free phosphorus compounds not specifically mentioned here can also be used, on their own or in any desired combination with other halogen-free phosphorus compounds.

Preferred mono- and oligomeric phosphoric or phosphonic acid esters are phosphorus compounds of general formula (V):

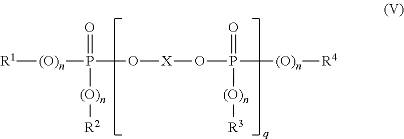

where
R¹, R², R³ and R⁴ independently of one another are in each case optionally halogenated C₁- to C₈-alkyl, or C₅- to C₆-cycloalkyl, C₆- to C₂₀-aryl or C₇- to C₁₂-aralkyl in each case optionally substituted by alkyl, preferably C₁- to C₄-alkyl, and/or halogen, preferably chlorine or bromine,
n independently of one another are 0 or 1,
q is 0 to 30 and
X is a mono- or polynuclear aromatic radical having 6 to 30 C atoms, or a linear or branched aliphatic radical having 2 to 30 C atoms, which can be OH-substituted and comprise up to eight ether linkages.

Preferably, R¹, R², R³ and R⁴ independently of one another are C₁- to C₄-alkyl, phenyl, naphthyl or phenyl-C₁-C₄-alkyl. The aromatic groups R¹, R², R³ and R⁴ can in turn be substituted by halogen and/or alkyl groups, preferably chlorine, bromine and/or C₁- to C₄-alkyl. Particularly preferred aryl radicals are cresyl, phenyl, xylenyl, propylphenyl or butylphenyl, as well as the corresponding brominated and chlorinated derivatives thereof.

X in formula (V) is preferably a mono- or polynuclear aromatic radical having 6 to 30 C atoms which is preferably derived from diphenols of formula (I).

n in formula (V) can independently of one another be 0 or 1. n is preferably equal to 1.

q has integral values from 0 to 30, preferably from 0 to 20 and particularly preferably from 0 to 10. In the case of mixtures q has mean values from 0.8 to 5.0, preferably from 1.0 to 3.0, more preferably from 1.05 to 2.00 and particularly preferably from 1.08 to 1.60.

X is particularly preferably

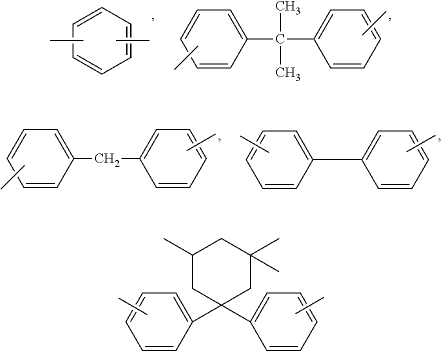

or their chlorinated or brominated derivatives. In particular, X is derived from resorcinol, hydroquinone, bisphenol A or diphenylphenol. Particularly preferably, X is derived from bisphenol A.

Phosphorus compounds of formula (V) are especially tributyl phosphate, triphenyl phosphate, tricresyl phosphate, diphenyl cresyl phosphate, diphenyl octyl phosphate, diphenyl 2-ethylcresyl phosphate, tri(isopropylphenyl) phosphate, resorcinol-bridged oligophosphate and bisphenol A-bridged oligophosphate. The use of oligomeric phosphoric acid esters of formula (V) derived from bisphenol A is particularly preferred.

The most preferred component D is an oligophosphate based on bisphenol A of formula (Va):

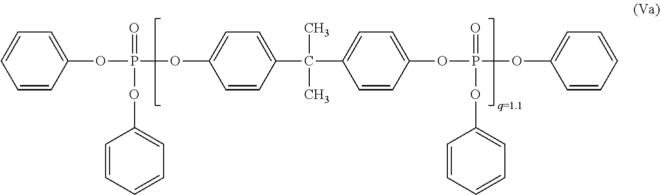

The phosphorus compounds of component D are known (cf., for example, EP-A 0 363 608, EP-A 0 640 655) or can be prepared analogously by known methods (e.g. Ullmanns Enzyklopädie der technischen Chemie, vol. 18, p. 301 et seq., 1979; Houben-Weyl, Methoden der organischen Chemie, vol. 12/1, p. 43; Beilstein, vol. 6, p. 177).

Mixtures of phosphates of different chemical structure and/or of identical chemical structure and different molecular weight can also be used as component D according to the invention.

It is preferable to use mixtures of identical structure and different chain length, the indicated q value being the mean q value. The mean q value is measured by determining the composition of the phosphorus compound (molecular weight distribution) by high pressure liquid chromatography (HPLC) at 40° C. in a mixture of acetonitrile and water (50:50) and calculating the mean values for q therefrom.

Other flameproofing agents which can be used are phosphonatamines such as those described in WO 00/00541 and WO 01/18105.

The flameproofing agents of component D can be used on their own, in any desired mixture with one another or in a mixture with other flameproofing agents.

When the compositions according to the invention comprise flame retardants, they preferably also comprise an antidripping agent, preferably polytetrafluoroethylene (PTFE).

Component E

Component E comprises one or more thermoplastic vinyl (co)polymers or polyalkylene terephthalates.

Suitable vinyl (co)polymers E are polymers of at least one monomer from the group comprising vinylaromatics, vinyl cyanides (unsaturated nitriles), (meth)acrylic acid C₁-C₈-alkyl esters, unsaturated carboxylic acids and derivatives (such as anhydrides and imides) of unsaturated carboxylic acids. Particularly suitable (co)polymers are those consisting of
E.1 50 to 99 parts by weight, preferably 60 to 80 parts by weight, of vinylaromatics and/or ring-substituted vinylaromatics (such as styrene, α-methylstyrene, p-methylstyrene, p-chlorostyrene) and/or (meth)acrylic acid C₁-C₈-alkyl esters (such as methyl methacrylate, ethyl methacrylate), and
E.2 1 to 50 parts by weight, preferably 20 to 40 parts by weight, of vinyl cyanides (unsaturated nitriles) (such as acrylonitrile and methacrylonitrile) and/or (meth)acrylic acid C₁-C₈-alkyl esters (such as methyl methacrylate, n-butyl acrylate, t-butyl acrylate) and/or unsaturated carboxylic acids (such as maleic acid) and/or derivatives (such as anhydrides and imides) of unsaturated carboxylic acids (e.g. maleic anhydride and N-phenylmaleimide).

The vinyl (co)polymers E are resinous, thermoplastic and rubber-free. The copolymer of styrene as E.1 and acrylonitrile as E.2 is particularly preferred.

The (co)polymers E are known and can be prepared by free-radical polymerization, especially by emulsion, suspension, solution or bulk polymerization. The (co)-polymers preferably have weight-average molecular weights M_{w} (determined by light scattering or sedimentation) of between 15,000 and 200,000 g/mol, particularly preferably of between 100,000 and 150,000 g/mol.

In one particularly preferred embodiment E is a copolymer of 77 wt % of styrene and 23 wt % of acrylonitrile with a weight-average molecular weight M_{w} of 130,000 g/mol.

According to the invention, the compositions comprise one polyalkylene terephthalate or a mixture of two or more different polyalkylene terephthalates as compounds that are suitable as component E.

In terms of the invention, polyalkylene terephthalates are those derived from terephthalic acid (or its reactive derivatives, e.g. dimethyl esters or anhydrides) and alkanediols, cycloaliphatic or araliphatic diols and mixtures thereof, e.g. based on propylene glycol, butanediol, pentanediol, hexanediol, 1,2-cyclohexanediol, 1,4-cyclohexanediol, 1,3-cyclohexanediol and cyclohexyldimethanol, the diol component according to the invention having more than 2 carbon atoms. Accordingly, it is preferable to use polybutylene terephthalate and/or poly-trimethylene terephthalate and most preferable to use polybutylene terephthalate as component E.

The polyalkylene terephthalates according to the invention can also comprise up to 5 wt % of isophthalic acid as a monomer of the diacid.

Preferred polyalkylene terephthalates can be prepared by known methods (Kunststoff-Handbuch, vol. VIII, p. 695 et seq., Carl-Hanser-Verlag, Munich 1973) from terephthalic acid (or its reactive derivatives) and aliphatic or cycloaliphatic diols having 3 to 21 C atoms.

Preferred polyalkylene terephthalates comprise at least 80 mol %, preferably at least 90 mol %, based on the diol component, of 1,3-propanediol and/or 1,4-butanediol radicals.

Apart from terephthalic acid radicals, the preferred polyalkylene terephthalates can comprise up to 20 mol % of radicals of other aromatic dicarboxylic acids having 8 to 14 C atoms or of aliphatic dicarboxylic acids having 4 to 12 C atoms, such as radicals of phthalic acid, isophthalic acid, naphthalene-2,6-dicarboxylic acid, biphenyl-4,4′-dicarboxylic acid, succinic acid, adipic acid, sebacic acid, azelaic acid, cyclohexanediacetic acid and cyclohexanedicarboxylic acid.

Apart from 1,3-propanediol or 1,4-butanediol radicals, the preferred polyalkylene terephthalates can comprise up to 20 mol % of other aliphatic diols having 3 to 12 C atoms or of cycloaliphatic diols having 6 to 21 C atoms, e.g. radicals of 2-ethyl-1,3-propanediol, neopentyl glycol, 1,5-pentanediol, 1,6-hexanediol, cyclohexane-1,4-dimethanol, 3-methyl-2,4-pentanediol, 2-methyl-2,4-pentanediol, 2,2,4-trimethyl-1,3-pentanediol, 2-ethyl-1,6-hexanediol, 2,2-diethyl-1,3-propanediol, 2,5-hexanediol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)-propane and 2,2-bis(4-hydroxypropoxyphenyl)propane (DE-A 24 07 674, 24 07 776, 27 15 932).

The polyalkylene terephthalates can be branched by the incorporation of relatively small amounts of tri- or tetrahydric alcohols or tri- or tetrabasic carboxylic acids, such as those described e.g. in DE-A 19 00 270 and U.S. Pat. No. 3,692,744. Examples of preferred branching agents are trimesic acid, trimellitic acid, trimethylolethane, trimethylolpropane and pentaerythritol.

It is advisable to use no more than 1 mol % of branching agent, based on the acid component.

Particularly preferred polyalkylene terephthalates are those which have been prepared only from terephthalic acid or its reactive derivatives (e.g. its dialkyl esters such as dimethyl terephthalate) and 1,3-propanediol and/or 1,4-butanediol (polypropylene terephthalate and polybutylene terephthalate) and mixtures of these polyalkylene terephthalates.

Other preferred polyalkylene terephthalates are copolyesters prepared from at least two of the aforementioned acid components and/or from at least two of the aforementioned alcohol components, particularly preferred copolyesters being poly(1,3-propylene glycol/1,4-butanediol) terephthalates.

The polyalkylene terephthalates generally have an intrinsic viscosity of approx. 0.4 to 1.5 dl/g, preferably of 0.5 to 1.3 dl/g, measured in each case in phenol/o-dichlorobenzene (1:1 parts by weight) at 25° C.

In one alternative embodiment the polyesters prepared according to the invention can also be used in a mixture with other polyesters and/or other polymers, preference being afforded to mixtures of polyalkylene terephthalates with other polyesters.

Other Additives F

The composition can comprise other conventional polymer additives such as flameproofing synergistic agents apart from antidripping agent, lubricants and demoulding agents (e.g. pentaerythritol tetrastearate), nucleating agents, stabilizers (e.g. UV/light stabilizers, heat stabilizers, antioxidants, transesterification inhibitors, hydrolysis stabilizers), antistatic agents (e.g. conductive carbon blacks, carbon fibres, carbon nanotubes and organic antistatic agents such as polyalkylene ethers, alkylsulfonates or polyamide-containing polymers), dyestuffs, pigments, fillers and reinforcing agents, especially glass fibres, mineral reinforcing agents and carbon fibres.

As stabilizers it is preferable to use sterically hindered phenols and phosphites or mixtures thereof, e.g. Irganox® B900 (Ciba Speciality Chemicals). As a demoulding agent it is preferable to use pentaerythritol tetrastearate. It is also preferable to add a black pigment (e.g. black pearls).

Apart from other optional additives, particularly preferred moulding compounds comprise as component F 0.1 to 1.5 parts by weight, preferably 0.2 to 1.0 part by weight and particularly preferably 0.3 to 0.8 part by weight of a demoulding agent, particularly preferably pentaerythritol tetrastearate.

Apart from other optional additives, particularly preferred moulding compounds comprise as component F 0.01 to 0.5 part by weight, preferably 0.03 to 0.4 part by weight and particularly preferably 0.06 to 0.3 part by weight of at least one stabilizer selected e.g. from the group comprising sterically hindered phenols, phosphites and mixtures thereof, particularly preferably Irganox® B900.

A combination of PTFE (component G), pentaerythritol tetrastearate and Irganox B900 with phosphorus-based flameproofing agents, as components C and D, is also particularly preferred.

Component G

Polytetrafluoroethylene (PTFE) or PTFE-containing compositions, e.g. master-batches of PTFE with polymers or copolymers comprising styrene or methyl methacrylate, are used in particular as antidripping agents, either as a powder or as a coagulated mixture, e.g. with component B.

The fluorinated polyolefins used as antidripping agents are high-molecular and have glass transition temperatures above −30° C., usually above 100° C., fluorine contents preferably of 65 to 76 wt %, especially of 70 to 76 wt %, and mean particle diameters d₅₀ of 0.05 to 1000 μm, preferably of 0.08 to 20 μm. In general the fluorinated polyolefins have a density of 1.2 to 2.3 g/cm³. Preferred fluorinated polyolefins are polytetrafluoroethylene, polyvinylidene fluoride, tetrafluoroethylene/hexafluoro-propylene copolymers and ethylene/tetrafluoroethylene copolymers. The fluorinated polyolefins are known (cf. “Vinyl and Related Polymers” by Schildknecht, John Wiley & Sons, Inc., New York, 1962, pages 484-494; “Fluoropolymers” by Wall, Wiley-Interscience, John Wiley & Sons, Inc., New York, volume 13, 1970, pages 623-654; “Modern Plastics Encyclopedia”, 1970-1971, volume 47, No. 10 A, October 1970, McGraw-Hill, Inc., New York, pages 134 and 774; “Modern Plastics Encyclopedia”, 1975-1976, October 1975, volume 52, No. 10 A, McGraw-Hill, Inc., New York, pages 27, 28 and 472; and U.S. Pat. Nos. 3,671,487, 3,723,373 and 3,838,092).

They can be prepared by known processes, e.g. by the polymerization of tetrafluoroethylene in an aqueous medium with a catalyst that forms free radicals, e.g. sodium, potassium or ammonium peroxydisulfate, at pressures of 7 to 71 kg/cm² and at temperatures of 0 to 200° C., preferably at temperatures of 20 to 100° C. (See e.g. U.S. Pat. No. 2,393,967 for further details.) Depending on the form in which they are used, the density of these materials can be between 1.2 and 2.3 g/cm³ and the mean particle size between 0.05 and 1000 μm.

The fluorinated polyolefins which are preferred according to the invention have mean particle diameters of 0.05 to 20 μm, preferably of 0.08 to 10 μm, and a density of 1.2 to 1.9 g/cm³.

Suitable fluorinated polyolefins G which can be used in powder form are tetrafluoroethylene polymers with mean particle diameters of 100 to 1000 μm and densities of 2.0 g/cm³ to 2.3 g/cm³. Suitable powders of tetrafluoroethylene polymers are commercially available products and are sold e.g. by DuPont under the trade name Teflon®.

Apart from other optional additives, particularly preferred flameproofed compositions comprise as component G 0.05 to 5.0 parts by weight, preferably 0.1 to

2.0 parts by weight and particularly preferably 0.1 to 1.0 part by weight of a fluorinated polyolefin.

The Examples which follow serve to illustrate the invention in greater detail.

Component A

Linear polycarbonate based on bisphenol A with a weight-average molecular weight M̅w of 27,500 g/mol (determined by GPC in dichloromethane with polycarbonate as standard).

Component B

ABS polymer prepared by the bulk polymerization of 82 wt %, based on the ABS polymer, of a mixture of 24 wt % of acrylonitrile and 76 wt % of styrene, in the presence of 18 wt %, based on the ABS polymer, of a polybutadiene/styrene block copolymer rubber with a styrene content of 26 wt %. The weight-average molecular weight M_{w} of the free SAN copolymer in the ABS polymer is 80,000 g/mol (measured by GPC in THF). The gel content of the ABS polymer is 24 wt % (measured in acetone).

Component C

Phenoxyphosphazene of formula (XI) with an oligomer content where k=1 of 70 mol %, an oligomer content where k=2 of 18 mol % and an oligomer content where k≧3 of 12 mol %.

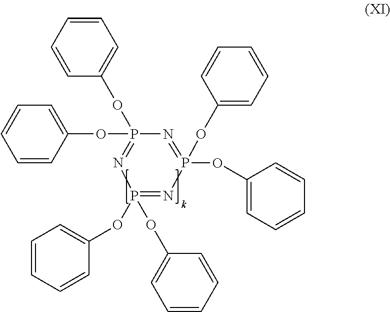

Component D

Oligophosphate based on bisphenol A with a phosphorus content of 8.9%.

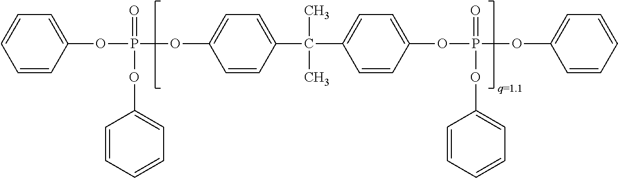

Component F1

Pentaerythritol tetrastearate as lubricant/demoulding agent.

Component F2

Heat stabilizer Irganox® B900 (mixture of 80% of Irgafos® 168 (tris(2,4-ditert-butylphenyl) phosphite) and 20% of Irganox® 1076 (2,6-ditert-butyl-4-(octa-decanoxycarbonylethyl)phenol); BASF AG; Ludwigshafen).

Component G

Coagulated mixture of emulsions of fluorinated polyolefins with emulsions of a copolymer based on styrene/acrylonitrile (50 wt % of each) (Cycolac INP 449 from Sabic).

Preparation and Testing of the Moulding Compounds

The starting materials listed in Table 1 are compounded and granulated on a twin-screw extruder (ZSK-25) (Werner and Pfleiderer) at a speed of rotation of 225 rpm, a throughput of 20 kg/h and a machine temperature of 260° C.

The finished granules are processed to the appropriate test pieces on an injection moulding machine (melt temperature 240° C., mould temperature 80° C., flow-front speed 240 mm/s)

The following methods were used to characterize the properties of the materials:

The IZOD notched impact strength was measured according to ISO 180/1A on 80 mm×10 mm×4 mm side-gated test bars.

The dimensional stability under heat was measured according to ISO 306 (Vicat softening point, method B with a load of 50 N and a heating rate of 120 K/h) on 80 mm×10 mm×4 mm side-gated test bars.

The melt flowability was assessed by means of the melt volume-flow rate (MVR), measured according to ISO 1133 at a temperature of 260° C. and with a plunger load of 5 kg.

The hydrolysis stability of the compositions prepared was measured as the change in MVR, measured according to ISO 1133 at 260° C. and with a plunger load of 5 kg, after storage of the granules for 7 days at 95° C. and 100% relative humidity (“FWL storage”). The increase in the MVR value compared with the MVR value before said storage was calculated as ΔMVR(hydr.), which is defined by the following formula:

$$Δ MVR ( hydr . ) = \frac{MVR ( after FWL storage ) - MVR ( before storage )}{MVR ( before storage )} \cdot 100 \%$$

The combustion behaviour was measured according to UL 94 V on 127×12.7×1.5 mm bars.

Table 1 shows that the compositions of Examples 4, 5 and 6, in which more than 50% of the amount of phosphorus required to achieve the UL 94 V-0 classification at 1.5 mm originates from the phosphazene component, achieve the object of the invention, i.e. exhibit a combination of high notched impact strength (no brittle fracture), dimensional stability under heat and hydrolysis stability (<100% deviation from the initial value of the MVR 260° C./5 kg after storage for 24 h/95° C./100% rel. humidity), coupled with a UL 94 V-0 classification at 1.5 mm

TABLE 1
Composition and properties of the moulding compounds

| | | 1 | 2 | 3 | | | 6 |
|---|---|---|---|---|---|---|---|
| | Unit | (Comp.) | (Comp.) | (Comp.) | 4 | 5 | (Comp.) |
| Components | | | | | | | |
| Component A | wt % | 71.0 | 71.7 | 72.5 | 73.2 | 73.9 | 74.7 |
| Component B | wt % | 15.0 | 15.2 | 15.3 | 15.5 | 15.6 | 15.8 |
| Component C | wt % | | 1.6 | 3.2 | 4.8 | 6.4 | 8.0 |
| Component D | wt % | 12.5 | 10.0 | 7.5 | 5.0 | 2.5 | |
| Component F-1 | wt % | 0.4 | 0.4 | 0.4 | 0.4 | 0.4 | 0.4 |
| Component F-2 | wt % | 0.2 | 0.2 | 0.2 | 0.2 | 0.2 | 0.2 |
| Component G | wt % | 0.9 | 0.9 | 0.9 | 0.9 | 0.9 | 0.9 |
| Properties | | | | | | | |
| Phosphorus content originating from component C | wt % | 0 | 0.2 | 0.4 | 0.65 | 0.9 | 1.1 |
| Phosphorus content originating from component D | wt % | 1.1 | 0.9 | 0.7 | 0.45 | 0.2 | 0 |
| Izod notched impact strength/RT (ISO 180/1A) - brittle | kJ/m² | 15 | 8 × 16 | 1 × 20 | | | |
| Izod notched impact strength/RT (ISO 180/1A) - tough | kJ/m² | | 2 × 44 | 9 × 48 | 53 | 65 | 69 |
| Vicat B 120 (ISO 306) | ° C. | 102 | 105 | 108 | 111 | 114 | 117 |
| MVR 260° C./5 kg (ISO 1133) | cm³/10 min | 21 | 19 | 18 | 15 | 13 | 12 |
| MVR 260° C./5 kg (ISO 1133) after storage for 24 h/95° C./ | cm³/10 min | 94 | 62 | 42 | 26 | 17 | 13 |
| 100% rel. humidity | | | | | | | |
| Deviation from initial value of MVR 260° C./5 kg (ISO 1133) | % | 348 | 226 | 133 | 73 | 31 | 8 |
| after storage for 24 h/95° C./100% rel. humidity | | | | | | | |
| UL 94 V 1.5 mm evaluation | | V-0 | V-0 | V-0 | V-0 | V-0 | V-0 |
| UL 94 V 1.5 mm total afterburn time | s | 11 | 15 | 15 | 15 | 24 | 27 |

1. Composition comprising
A) 48-95 parts by weight of aromatic polycarbonate and/or aromatic polyestercarbonate,
B) 1.0-20.0 parts by weight of rubber-modified graft polymer,
C) 1.0-20.0 parts by weight of at least one cyclic phosphazene of formula (X): 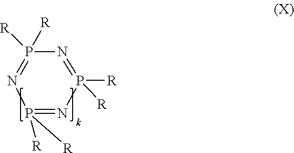
where
k is 1 or an integer from 1 to 10, optionally a number from 1 to 8 and optionally 1 to 5,
the trimer content (k=1) being from 60 to 98 mol %, based on component C,
and
R are in each case identical or different and are an amine radical, C₁- to C₈-alkyl in each case optionally halogenated, optionally with fluorine, preferably methyl, ethyl, propyl or butyl, C₁- to C₈-alkoxy, optionally methoxy, ethoxy, propoxy or butoxy, C₅- to C₆-cycloalkyl in each case optionally substituted by alkyl, preferably C₁-C₄-alkyl, and/or halogen, preferably chlorine and/or bromine, C₆- to C₂₀-aryloxy in each case optionally substituted by alkyl, preferably C₁-C₄-alkyl, and/or halogen, optionally chlorine or bromine, and/or hydroxyl, preferably phenoxy or naphthyloxy, C₇- to C₁₂-aralkyl in each case optionally substituted by alkyl, preferably C₁-C₄-alkyl, and/or halogen, optionally chlorine and/or bromine, optionally phenyl-C₁-C₄-alkyl, or a halogen radical, optionally chlorine, or an OH radical,
D) 1.0-7.0 parts by weight of at least one phosphorus-containing organic flameproofing agent other than C,
E) 0-15.0 parts by weight of one or more rubber-free vinyl (co)polymer or polyalkylene terephthalates,
F) 0-15.0 parts by weight of one or more additives and
G) 0.05 to 5.00 parts by weight of antidripping agent,
all the parts by weight optionally being scaled so that the sum of the parts by weight of all the components A+B+C+D+E+F+G in the composition is 100, and
at least 50% of the amount of phosphorus in the composition originating from component C.

2. Composition according to claim 1, wherein the trimer content (k=1) is 60 to 98 mol %, optionally 65 to 95 mol % and optionally 65 to 90 mol %, based on component C.

3. Composition according to claim 1, wherein the proportion of component C is 4.0-10.0 parts by weight.

4. Composition according to claim 1, wherein
component C is selected from the group comprising propoxyphosphazenes, phenoxyphosphazenes, methylphenoxyphosphazenes, aminophosphazenes and fluoroalkylphosphazenes.

5. Composition according to claim 1, wherein R=phenoxy.

6. Composition according to claim 1, wherein the trimer content (k=1) is 65-85 mol %, based on component C.

7. Composition according to claim 1, wherein the trimer content (k=1) is from 65 to 85 mol %, the tetramer content (k=2) is from 10 to 20 mol %, the higher oligomeric phosphazene content (k=3, 4, 5, 6 and 7) is from 5 to 15 mol % and the phosphazene oligomer content where k≧8 is from 0 to 1 mol %, based in each case on component C.

8. Composition according to claim 1, wherein component D is present in a proportion of 2.2-5.5 parts by weight.

9. Composition according to claim 1, the phosphorus-containing flameproofing agent (D) is an oligophosphate based on bisphenol A of formula (Va):

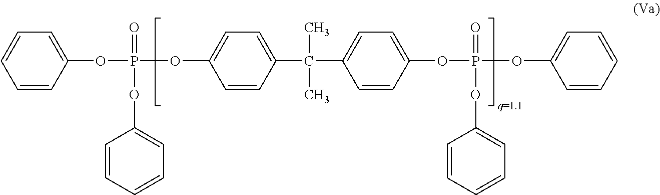

10. Composition according to claim 1 which comprise as component F at least one additive selected from the group comprising flameproofing synergistic agents, antidripping agents, lubricants and demoulding agents, nucleating agents, stabilizers, antistatic agents, dyestuffs, pigments, fillers and reinforcing agents.

11. Composition according to claim 1, wherein the graft base of component B is selected from the group comprising diene rubbers, EP(D)M rubbers, and acrylate, polyurethane, silicone, chloroprene and ethylene/vinyl acetate rubbers.

12. Composition according to claim 1, wherein component B is a bulk polymer.

13. A cyclic phosphazene of formula (X): 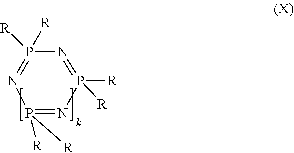
Capable of being used for preparation of flameproofed polymer composition with a combination of properties comprising good notched impact strength, high dimensional stability under heat and high hydrolysis stability, the UL 94 V-0 classification remaining good at 1.5 mm,
where
k is 1 or an integer from 1 to 10, optionally a number from 1 to 8 and optionally 1 to 5,
the trimer content (k=1) being from 60 to 98 mol %, based on component C,
and
R are in each case identical or different and are an amine radical, C₁- to C₈-alkyl in each case optionally halogenated, preferably with fluorine, optionally methyl, ethyl, propyl or butyl, C₁- to C₈-alkoxy, optionally methoxy, ethoxy, propoxy or butoxy, C₅- to C₆-cycloalkyl in each case optionally substituted by alkyl, optionally C₁-C₄-alkyl, and/or halogen, optionally chlorine and/or bromine, C₆- to C₂₀-aryloxy in each case optionally substituted by alkyl, preferably C₁-C₄-alkyl, and/or halogen, optionally chlorine or bromine, and/or hydroxyl, preferably phenoxy or naphthyloxy, C₇- to C₁₂-aralkyl in each case optionally substituted by alkyl, optionally C₁-C₄-alkyl, and/or halogen, preferably chlorine and/or bromine, optionally phenyl-C₁-C₄-alkyl, or a halogen radical, optionally chlorine, or an OH radical.

14. A composition according to claim 1 capable of being used for production of injection-moulded and/or thermoformed articles.

15. Moulded article obtainable from a composition according to claim 1.
